(19) United States
(12) Patent Application Publication
(10) Pub. No.: US 2018/0136710 A1
(43) Pub. Date: May 17, 2018

(54) POWER SUPPLY DEVICE

(71) Applicant: ALSON TECHNOLOGY LIMITED, KOWLOON (HK)

(72) Inventors: Han-Hung CHENG, Zhubei City (TW); Chi-Fen KUO, Zhubei City (TW)

(21) Appl. No.: 15/354,176

(22) Filed: Nov. 17, 2016

(51) Int. Cl. G06F 1/32

(52) U.S. Cl. CPC G06F 1/3287; G06F 1/324

(57) ABSTRACT

A power supply device is provided, including a base body and a light-emitting module. The base body has a light-penetrable portion, a shell body and a power transfer unit, the shell body defines a receiving space, the light-penetrable portion is arranged on the shell body, and the power transfer unit is received in the receiving space. The light-emitting module is arranged on the shell body and includes a substrate, a boost circuit and a plasma tube, the boost circuit is arranged on the substrate, the plasma tube has a light-emitting main body and two electrodes, and the light-emitting portion at least partly corresponds to the light-penetrable portion.

### BACKGROUND OF THE INVENTION

### Field of the Invention

The present invention relates to a power supply device.

### Description of the Prior Art

A computer (a computing apparatus) can instantly provide various functions, for example, accessing information, processing image, transmitting information and analyzing data. Nowadays, a computer has become an integral part of people's life. One of major components of a computer is a power supply unit (PSU), and the power supply unit is for transferring an AC power which is usually used into a DC power which is more stable for other computer components to use.

The prior art focuses more on developing a transferring efficiency, an output stability and a heat-dissipating system of the power supply unit. Although the power supply unit has a preferable efficacy, users hope to have a power supply device which has functions of multiple areas.

The present invention has arisen to mitigate and/or obviate the afore-described disadvantages.

### SUMMARY OF THE INVENTION

The major object of the present invention is to provide a power supply device, which illuminate a space through a plasma tube, and when a user is in a dark environment, s/he can see objects around him/her clearly and recognize a location of the power supply device quickly so as to prevent from colliding with the objects around him/her. In addition, a light emitted from the plasma tube is not uncomfortable to human eyes.

To achieve the above and other objects, a power supply device is provided for supplying energy to a computer component. The power supply device includes a base body and a light-emitting module. The base body has a light-penetrable portion, a shell body and a power transfer unit, the shell body defines a receiving space, the light-penetrable portion is arranged on the shell body, the power transfer unit is received in the receiving space, the power transfer unit includes a circuit substrate, a transfer module and an output module, the circuit substrate is for being electrically connected to a first power source, the transfer module is electrically connected to the circuit substrate, the output module is electrically connected to the circuit substrate and for being electrically connected to the computer component, the transfer module is for transferring a first electric energy of the first power source into a second electric energy, and the output module is for transmitting the second electric energy to the computer component. The light-emitting module is arranged on the shell body, the light-emitting module includes a substrate, a boost circuit and a plasma tube, the boost circuit is arranged on the substrate, the boost circuit includes at least one conductive wire and a plurality of electronic components, the electronic components are electrically connected to the at least one conductive wire, the at least one conductive wire includes a power input portion and two power output portions, the power input portion is for being electrically connected to a second power source, the plasma tube has a light-emitting main body and two electrodes, the light-emitting portion at least partly corresponds to the light-penetrable portion, and the two electrodes are arranged on the light-emitting main body and respectively electrically connected to the two power output portions.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an embodiment of the present invention;

FIG. 2 is a breakdown view of FIG. 1;

FIG. 3 is a drawing showing the embodiment of the present invention in use;

FIGS. 4 and 5 are partially cross-sectional views of FIG. 1;

FIG. 6 is a block diagram showing a relation of a light-emitting module of the embodiment of the present invention;

FIG. 7 is a block diagram showing a relation of a detecting unit of the embodiment of the present invention; and

FIG. 8 is a partially cross-sectional view of another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

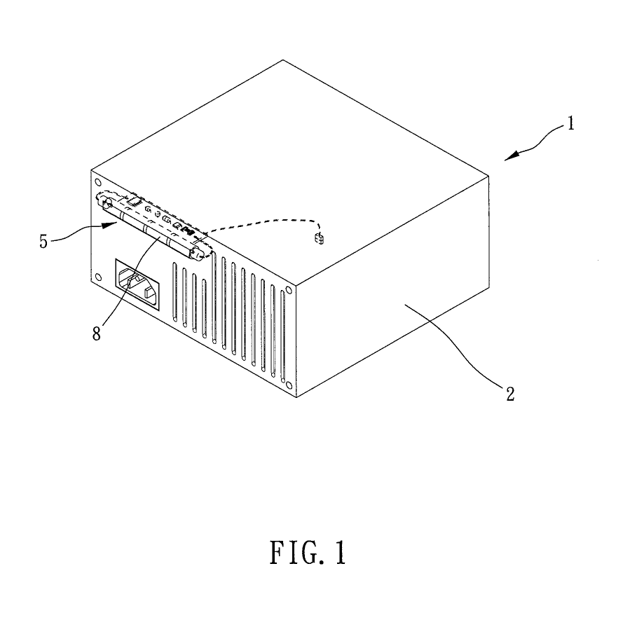

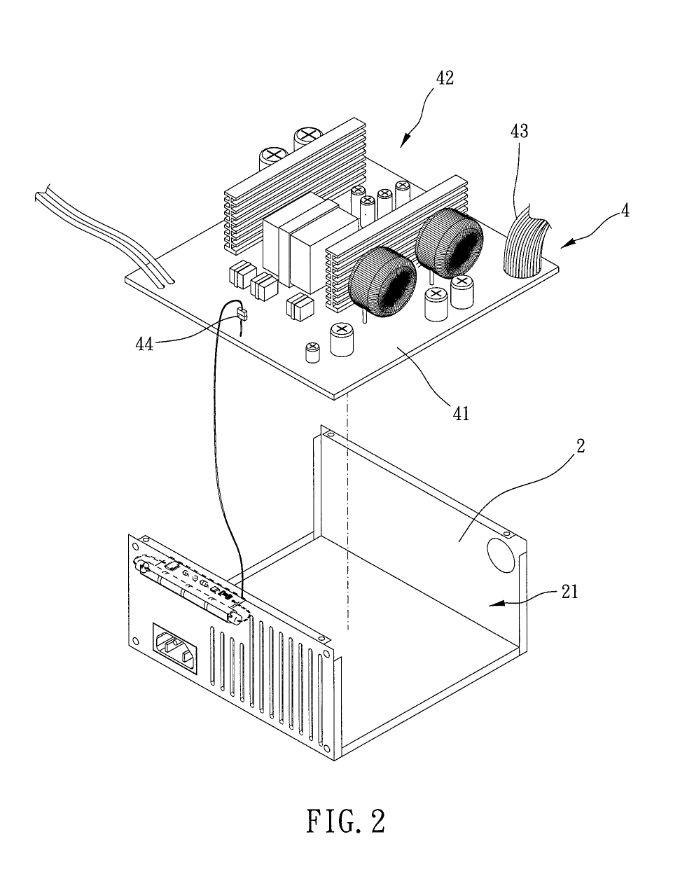

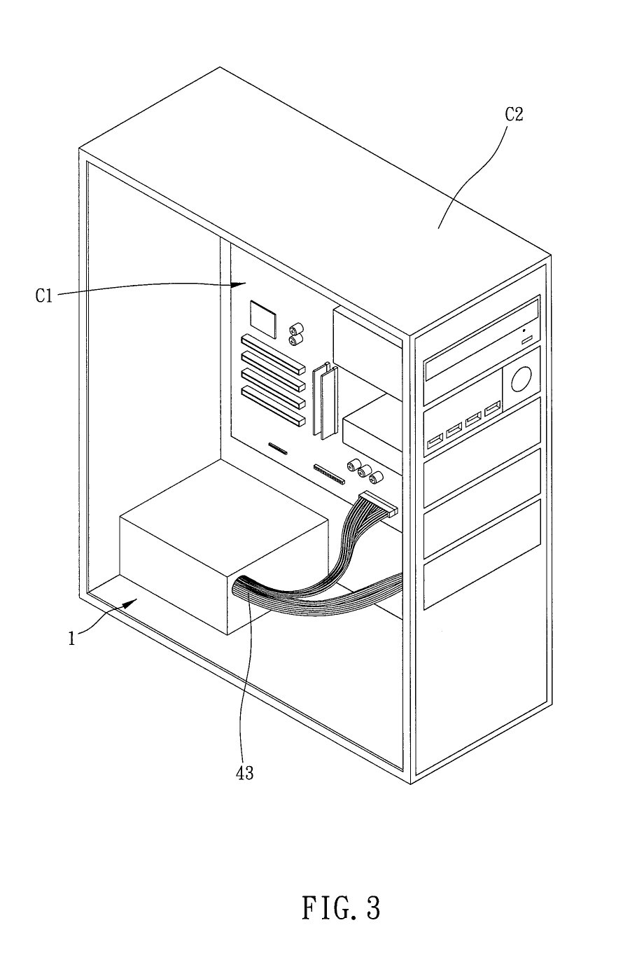

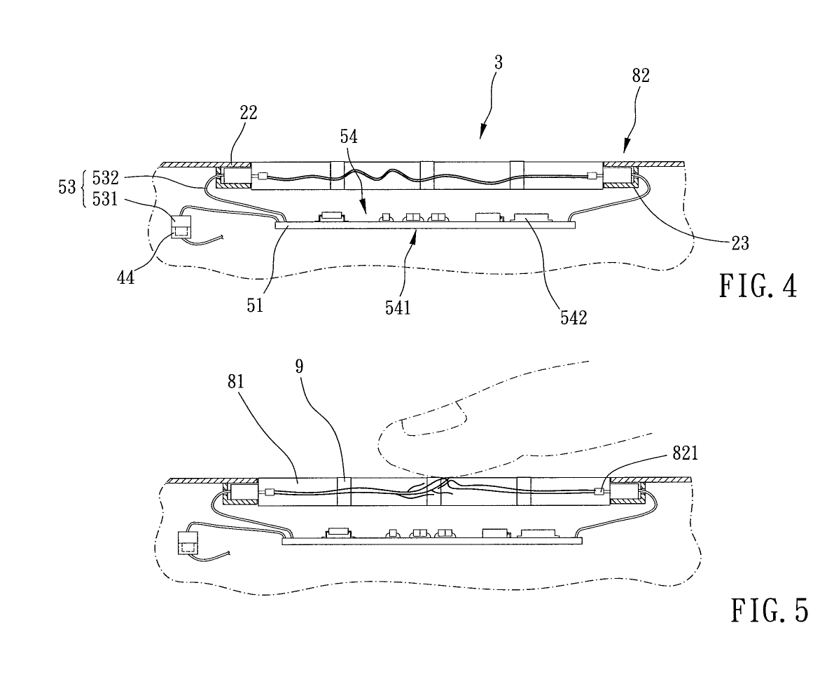

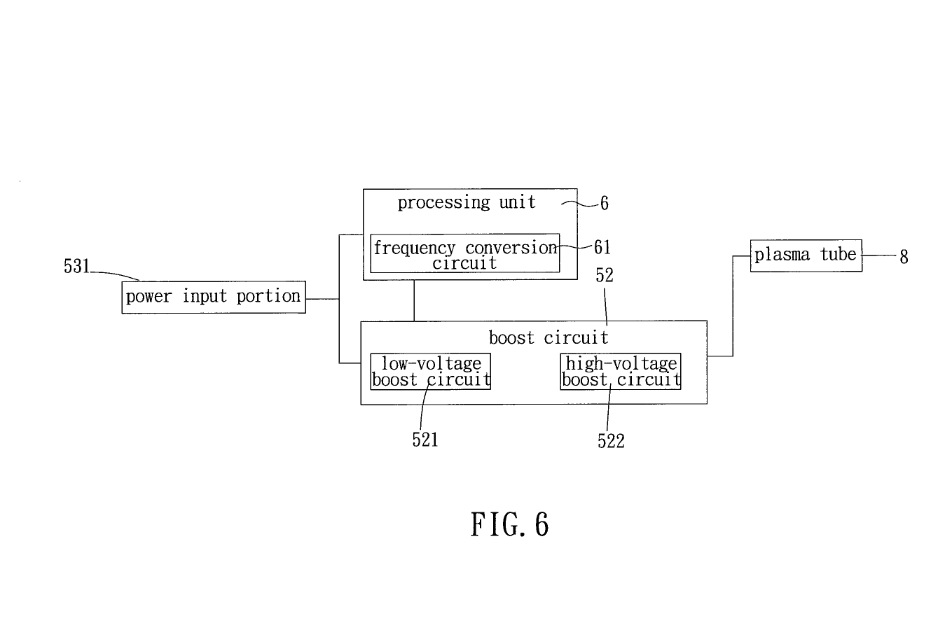

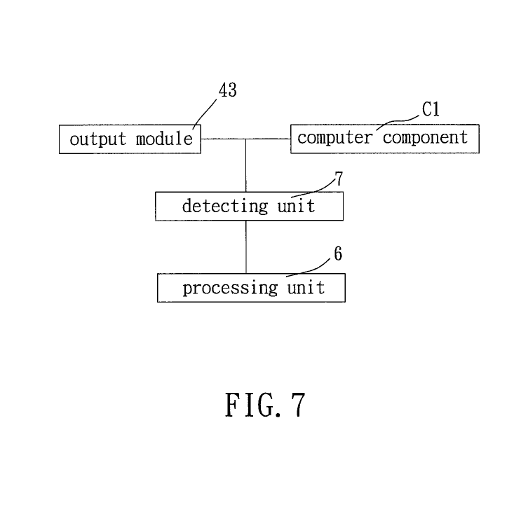

Please refer to FIGS. 1 to 7 for an embodiment of the present invention. A power supply device provides energy to a computer component C1, and the power supply device includes a base body 1 and a light-emitting module 5.

The base body 1 has a light-penetrable portion 3, a shell body 2 and a power transfer unit 4, the shell body 2 defines a receiving space 21, the light-penetrable portion 3 is arranged on the shell body 2, the power transfer unit 4 is received in the receiving space 21, the power transfer unit 4 includes a circuit substrate 41, a transfer module 42 and an output module 43, the circuit substrate 41 is for being electrically connected to a first power source, the transfer module 42 is electrically connected to the circuit substrate 41, and the output module 43 is electrically connected to the circuit substrate 41 and for being electrically connected to the computer component C1. Specifically, the transfer module 42 is for transferring a high-voltage AC which is commonly transmitted into a low-voltage DC which is stable for the computer component C1 to use.

The light-emitting module 5 is arranged on the shell body 2, the light-emitting module 5 includes a substrate 51, a boost circuit 52 and a plasma tube 8, the boost circuit 52 is arranged on the substrate 51, the boost circuit 52 includes at least one conductive wire 53 and a plurality of electronic components 54, the electronic components 54 are electrically connected to the at least one conductive wire 53, the at least one conductive wire 53 includes a power input portion 531 and two power output portions 532, the power input portion 531 is for being electrically connected to a second power source, the plasma tube 8 has a light-emitting main body 81 and two electrodes 82, the light-emitting portion 81 at least partly corresponds to the light-penetrable portion 3, and the two electrodes 82 are arranged on the light-emitting main body 81 and respectively electrically connected to the two power output portions 532.

In this embodiment, the power supply device is for being received in a computer case C2, the light-emitting module 5 is arranged on a side face of the shell body 2 which is non-covered by the computer case C2, and the light-emitting module 5 is located in the receiving space 21. It is understandable that in other embodiments, as a position of the power supply device arranged on the computer case C2, the light-emitting module 5 may be arranged on any position of the shell body 2. It is to be noted that the circuit substrate 41 further has a power source connecting portion 44, and the power source connecting portion 44 is electrically connected to the power input portion 531 so that the circuit substrate 41 can transmit power to the light-emitting module 5. In other words, in this embodiment, the first and second power sources are the same; and in other embodiments, the first and second power sources may be independently separated.

Specifically, the conductive wires 53 are buried in the substrate 51, the substrate 51 and the conductive wires 53 form a printed circuit board, and of course, the conductive wires 53 may be arranged on the substrate 51 in other ways. The light-emitting main body 81 is columnar, the two electrodes 82 are arranged on two opposite ends of the light-emitting main body 81, and the light-emitting main body 81 and the two electrodes 82 are coaxially arranged. The light-emitting main body 81 is greater than each said electrode 82 in radial dimension. In addition, each said electrode 82 includes an electrode cap 821 which is located within the light-emitting main body 81 and is hollow, and the two electrode caps 821 are coaxially arranged so that light is emitted along a periphery of the electrode caps 821 to emit light evenly.

More specifically, the light-penetrable portion 3 is a through hole, the light-emitting main body 81 is exposed through the through hole and non-protrusive outside the shell body 2, and in a dark environment, the light emitted from the plasma tube 8 will not be uncomfortable to human eyes. In addition, light from the light-emitting main body 81 can illuminate surroundings and objects (for example, a power cord) directly and clearly to prevent people from being tumbled and getting hurt. It is to be noted that when a user touches the light-emitting main body 81 with fingers, a part of the light in the light-emitting main body 81 is guided to a place that s/he touches and produces a special light path due to electron neutralization (a human body functions as an earth wire), and the through hole is for the user to touch the light-emitting main body 81 conveniently to produce the above-mentioned effect.

It is to be noted that the light-emitting main body 81 is non-protrusive outside the shell body 2, and the light-emitting main body 81 can not only illuminate the surroundings but also effectively prevent the light-emitting main body 81 from being collided unexpectedly so as to protect a structural integrity of the light-emitting main body 81. Preferably, in an opening direction of the through hole, the shell body 2 covers the two electrodes 82 completely to prevent the user from touching the electrode 82 and suffering from electric shock, and the shell body 2 can prevent foreign objects from attaching on each said electrode 82.

More preferably, the shell body 2 includes an assembling portion 22 which is made of an insulating material and a positioning portion 23, the assembling portion 22 has the light-penetrable portion 3, the positioning portion 23 is connected to the assembling portion 22, the light-emitting module 5 is arranged on the assembling portion 22, and the plasma tube 8 is positioned on the positioning portion 23. It is understandable that the assembling portion 22 can effectively prevent the user from touching the power supply device and suffering from electric shock when the power supply device is leaking electricity, and the positioning portion 23 can prevent the plasma tube 8 from moving relative to the shell body 2 to prevent collision.

More preferably, the light-emitting module 5 further includes at least one protection member 9, and each said protection member 9 covers at least a part of the light-emitting main body 81. More specifically, each said protection member 9 is made of a material which is flexible, cushionable and light-penetrable. Therefore, each said protection member 9 can be firmly wound around the light-emitting main body 81 without covering the light emitted from the light-emitting main body 81. In addition, when there is collision, each said protection member 9 can absorb or dissipate impact to protect the structural integrity of the light-emitting main body 81.

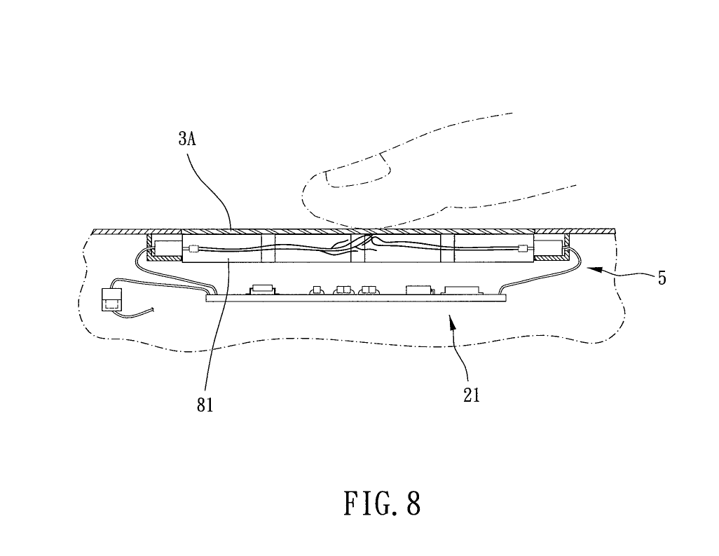

It is understandable that the light-penetrable portion 3 may be in other modes. Please refer to another embodiment in FIG. 8. A light-penetrable portion 3A is a cover board made of a light-penetrable material, the light-emitting module is arranged in the receiving space 21, and the cover board covers the light-emitting main body 81 so that the cover board can protect the light-emitting main body 81 completely and prevent foreign objects from contacting the light-emitting main body 81. The light-emitting main body 81 is preferably neighboring to the light-penetrable portion 3A to avoid influencing the special effect that the human body guides the light, for example, the light-emitting main body 81 is tight fit on the cover board. In other embodiments, the cover board may be a part of the shell body, or the whole shell body may be made of a transparent material.

Please further refer to the embodiment in FIGS. 1 to 7. It is to be noted that the boost circuit 52 of the light-emitting module 5 is to transfer a low-voltage DC which is input from the power input portion 531 into a high-voltage AC, and the high-voltage AC is output through the two power output portions 532 for the plasma tube 8 to use. Of course, according to the types or requirements of the plasma tube 8, the boost circuit 52 may transfer the low-voltage DC into a high-voltage pulsed DC.

Furthermore, the light-emitting module 5 further includes a processing unit 6 arranged on the substrate 51, the processing unit 6 includes a frequency conversion circuit 61 which is electrically connected to the power input portion 531 and the boost circuit 52, the frequency conversion circuit 61 is for transferring an input power source having a first frequency which is input from the power input portion 531 into at least one output power source having a second frequency and an output power source having a third frequency and transmitting the at least one output power source having the second frequency and the output power source having the third frequency to the boost circuit 52 sequentially, the first and second frequencies are different, and the second and third frequencies are different. Therefore, the plasma tube 8 inputs power sources having different frequencies according to the boost circuit 52 to produce the light which is fluctuated.

Specifically, the plurality of electronic components 54 include a plurality of passive components 541 and at least one transformer 542, and the plurality of passive components 542 are electrically connected to each other to form a low-voltage boost circuit 521 which is electrically connected to the power input portion 531 and the processing unit 6 so as to boost the power provided by the circuit substrate 41, for example, from 1.5˜3.5 V to 12˜15 V. The at least one transformer 542 forms a high-voltage boost circuit 522 which is electrically connected to the low-voltage boost circuit 521 and the two power output portions 532 so as to transfer a low-voltage power into a high-voltage electricity for the plasma tube 8 to use, for example, from 12˜15 V to 700˜900 V.

Preferably, the light-emitting module 5 further includes a detecting unit 7 arranged on the substrate 51, the detecting unit 7 is electrically connected to the output module 43 and the processing unit 6, the detecting unit 7 is for detecting an output power of the output module 43 and transferring the output power into a signal, the detecting unit 7 transmits the signal to the processing unit 6, and as the processing unit 6 receives the signal, the frequency conversion circuit 61 is controlled to adjust the second and third frequencies according to a corresponding mode. The corresponding mode, for example but not limited thereto, when the output power of the output module 43 rises, the frequency conversion circuit 61 adjust the second and third frequencies to increase gradually so that the light emitted from the plasma tube 8 waves and flashes more quickly, and through watch the light, the user knows a load of the power supply device in operation.

Given the above, in a dark environment, the power supply device can illuminate the surroundings so that the user will not be tumbled by objects (for example, the power cord), and the user can observe a flash frequency of the light to quickly determine how strong the output power is. In addition, the light-emitting module provides a plurality of protection measures to prevent collision, touching inadvertently and electric shock.

While we have shown and described various embodiments in accordance with the present invention, it should be clear to those skilled in the art that further embodiments may be made without departing from the scope of the present invention.

What is claimed is:

1. A power supply device, for supplying energy to a computer component, the power supply device including:
a base body, having a light-penetrable portion, a shell body and a power transfer unit, the shell body defining a receiving space, the light-penetrable portion arranged on the shell body, the power transfer unit received in the receiving space, the power transfer unit including a circuit substrate, a transfer module and an output module, the circuit substrate for being electrically connected to a first power source, the transfer module being electrically connected to the circuit substrate, the output module being electrically connected to the circuit substrate and for being electrically connected to the computer component, wherein the transfer module is for transferring a first electric energy of the first power source into a second electric energy, and the output module is for transmitting the second electric energy to the computer component;
a light-emitting module, arranged on the shell body, including a substrate, a boost circuit and a plasma tube, the boost circuit being arranged on the substrate, the boost circuit including at least one conductive wire and a plurality of electronic components, the electronic components being electrically connected to the at least one conductive wire, the at least one conductive wire including a power input portion and two power output portions, the power input portion for being electrically connected to a second power source, the plasma tube having a light-emitting main body and two electrodes, the light-emitting portion at least partly corresponding to the light-penetrable portion, the two electrodes being arranged on the light-emitting main body and respectively electrically connected to the two power output portions.

2. The power supply device of claim 1, wherein the light-emitting module is located in the receiving space, the light-penetrable portion is a through hole, the light-emitting main body is exposed through the through hole and non-protrusive outside the shell body, and in an opening direction of the through hole, the shell body covers the two electrodes completely.

3. The power supply device of claim 1, wherein the light-penetrable portion is a cover board made of a light-penetrable material, the light-emitting module is arranged in the receiving space, and the cover board covers the light-emitting main body.

4. The power supply device of claim 1, wherein the light-emitting module further includes at least one protection member, and each said protection member covers at least a part of the light-emitting main body.

5. The power supply device of claim 1, wherein the light-emitting module further includes a processing unit arranged on the substrate, the processing unit includes a frequency conversion circuit which is electrically connected to the power input portion and the boost circuit, the frequency conversion circuit is for transferring an input power source having a first frequency which is input from the power input portion into at least one output power source having a second frequency and an output power source having a third frequency and transmitting the at least one output power source having the second frequency and the output power source having the third frequency to the boost circuit sequentially, the first and second frequencies are different, and the second and third frequencies are different.

6. The power supply device of claim 5, wherein the light-emitting module further includes a detecting unit arranged on the substrate, the detecting unit is electrically connected to the output module and the processing unit, the detecting unit is for detecting an output power of the output module and transferring the output power into a signal, the detecting unit transmits the signal to the processing unit, and as the processing unit receives the signal, the frequency conversion circuit is controlled to adjust the second and third frequencies according to a corresponding mode.

7. The power supply device of claim 5, wherein the plurality of electronic components include a plurality of passive components and at least one transformer, the plurality of passive components are electrically connected to each other to form a low-voltage boost circuit which is electrically connected to the power input portion and the processing unit, and the at least one transformer forms a high-voltage boost circuit which is electrically connected to the low-voltage boost circuit and the two power output portions.

8. The power supply device of claim 1, wherein the shell body includes an assembling portion which is made of an insulating material and a positioning portion, the assembling portion has the light-penetrable portion, the positioning portion is connected to the assembling portion, the light-emitting module is arranged on the assembling portion, and the plasma tube is positioned on the positioning portion.

9. The power supply device of claim 6, wherein the light-emitting module is located in the receiving space, the light-penetrable portion is a through hole, the light-emitting main body is exposed through the through hole and non-protrusive outside the shell body, and in an opening direction of the through hole, the shell body covers the two electrodes completely; the light-emitting module further includes at least one protection member, and each said protection member covers at least a part of the light-emitting main body; the plurality of electronic components include a plurality of passive components and at least one transformer, the plurality of passive components are electrically connected to each other to form a low-voltage boost circuit which is electrically connected to the power input portion and the processing unit, and the at least one transformer forms a high-voltage boost circuit which is electrically connected to the low-voltage boost circuit and the two power output portions; the shell body includes an assembling portion which is made of an insulating material and a positioning portion, the assembling portion has the light-penetrable portion, the positioning portion is connected to the assembling portion, the light-emitting module is arranged on the assembling portion, and the plasma tube is positioned on the positioning portion; the power supply device is for being received in a computer case, and the light-emitting module is arranged on a side face of the shell body which is non-covered by the computer case; the circuit substrate further has a power source connecting portion, and the power source connecting portion is electrically connected to the power input portion; the two electrodes are arranged on two opposite ends of the light-emitting main body, and the light emitting main body and the two electrodes are coaxially arranged; each said electrode includes an electrode cap which is located within the light-emitting main body and is hollow, and the two electrode caps are coaxially arranged; and the protection member is made of a material which is flexible, cushionable and light-penetrable.
